(19) United States
(12) Patent Application Publication
(10) Pub. No.: US 2021/0133935 A1
(43) Pub. Date: May 6, 2021

(54) IMAGE PROCESSING DEVICE, DISPLAY DEVICE, IMAGE PROCESSING METHOD, AND NON-TRANSITORY COMPUTER-READABLE RECORDING MEDIUM

(71) Applicant: SHARP KABUSHIKI KAISHA, Sakai City, Osaka (JP)

(72) Inventors: SHIGETO YOSHIDA, Sakai City, Osaka (JP); NAOKO GOTO, Sakai City, Osaka (JP); AYA OKAMOTO, Sakai City, Osaka (JP); CHUNLIN LU, Sakai City, Osaka (JP)

(21) Appl. No.: 16/769,100

(22) PCT Filed: Dec. 4, 2018
(86) PCT No.: PCT/JP2018/044618

§ 371 Date: Jun. 2, 2020

(30) Foreign Application Priority Data
Dec. 5, 2017 (JP) 2017-233622

(51) Int. Cl. G06T 5/00; G09G 3/20; G09G 5/10

(52) U.S. Cl. CPC G06T 5/004; G06T 5/009; G09G 2320/0646; G09G 5/10; G09G 3/2003

(57) ABSTRACT

An image processing device that generates an output image displayed on a display device that controls a plurality of light sources corresponding to a display region in a nonrectangular shape, the image processing device comprising: a masking processing unit that uses a region other than the display region in an input image, which is input from outside, as a masking processing region to perform masking processing for the masking processing region and generates a masking processed image; a luminance data creation unit that creates luminance data, which indicates luminance of the plurality of light sources when an output image corresponding to the input image is displayed, on a basis of the masking processed image; and an output image creation unit that creates the output image on a basis of the luminance data and the input image or the masking processed image.

### TECHNICAL FIELD

The following disclosure relates to an image processing device, a display device, an image processing method, a program, and a recording medium.

### BACKGROUND ART

High dynamic range (HDR) display techniques have been recently studied to display a picture image with wider dynamic range. Among them, many studies on a technique called “local dimming” in which a display unit is divided into a plurality of regions (dimming regions) and a light quantity of a backlight in each of the regions obtained by division is adjusted on the basis of a luminance component of picture image data have been conducted. In the local dimming, control is performed so that a light quantity of a light source corresponding to a bright region of a picture image is increased, whereas a light quantity of a light source corresponding to a dark region of the picture image is reduced. Thereby, it is possible to make the bright region of the picture image brighter and the dark region of the picture image darker, thus making it possible to display the picture image at a high contrast ratio with wider dynamic range.

PTL 1 discloses a liquid crystal display device that includes a backlight divided into some blocks luminance of which is able to be adjusted independently, and a local dimming control circuit. The local dimming control circuit calculates luminance data of each of the blocks of the backlight on the basis of a content of picture image data.

### CITATION LIST

### Patent Literature

PTL 1: WO2014/115449 (published on Jul. 31, 2014)

### SUMMARY OF INVENTION

### Technical Problem

However, PTL 1 discloses nothing about a liquid crystal display device having a display region in a nonrectangular shape. Thus, in a case where a shape of a display region is nonrectangular in the liquid crystal display device disclosed in PTL 1, deterioration in image quality may be caused.

An aspect of the disclosure aims to achieve an image processing device or the like that is able to suppress deterioration in image quality in a display device in a nonrectangular shape.

### Solution to Problem

In order to solve the aforementioned problem, an image processing device according to an aspect of the disclosure is an image processing device that generates an output image displayed on a display device that controls lighting of a plurality of light sources corresponding to a display region in a nonrectangular shape, and the image processing device includes: a masking processing unit that uses a region other than the display region in an input image, which is input from outside, as a masking processing region to perform masking processing for the masking processing region and generates a masking processed image; a luminance data creation unit that creates luminance data, which indicates luminance of the plurality of light sources when an output image corresponding to the input image is displayed, on a basis of the masking processed image; and an output image creation unit that creates the output image on a basis of the luminance data and the input image or the masking processed image.

Moreover, an image processing method according to an aspect of the disclosure is an image processing method of generating an output image displayed on a display device that controls lighting of a plurality of light sources corresponding to a display region in a nonrectangular shape, and the image processing method includes the steps of: using a region other than the display region in an input image, which is input from outside, as a masking processing region to perform masking processing for the masking processing region and generating a masking processed image; creating luminance data, which indicates luminance of the plurality of light sources when an output image corresponding to the input image is displayed, on a basis of the masking processed image; and creating the output image on a basis of the luminance data and the input image or the masking processed image.

A program according to an aspect of the disclosure is a program causing a computer to function as an image processing device that generates an output image displayed on a display device that controls lighting of a plurality of light sources corresponding to a display region in a nonrectangular shape, and causing the computer to function as a masking processing unit that uses a region other than the display region in an input image, which is input from outside, as a masking processing region to perform masking processing for the masking processing region and generates a masking processed image, a luminance data creation unit that creates luminance data, which indicates luminance of the plurality of light sources when an output image corresponding to the input image is displayed, on a basis of the masking processed image, and an output image creation unit that creates the output image on a basis of the luminance data and the input image or the masking processed image.

### Advantageous Effects of Invention

With an image processing device or the like according to an aspect of the disclosure, deterioration in image quality in a display device in a nonrectangular shape is able to be suppressed.

### BRIEF DESCRIPTION OF DRAWINGS

FIG. 1 is a block diagram illustrating a configuration of a display device according to Embodiment 1.

FIG. 2(a) illustrates an inner configuration of the display device according to Embodiment 1 and FIG. 2(b) illustrates a configuration of an illumination device provided in the display device illustrated in FIG. 2(a).

FIG. 3 illustrates processing by a masking processing unit, in which FIG. 3(a) illustrates an input image and FIG. 3(b) illustrates a masking processed image.

FIG. 4 is a flowchart illustrating an example of an image processing method in an image processing device of the display device according to Embodiment 1.

FIG. 5 illustrates a configuration of a display device as a comparative example.

FIG. 6 is a view for explaining luminance data in an image processing device as the comparative example, in which FIG. 6(a) illustrates an example of an input image, FIG. 6(b) illustrates a shape of a display region, FIG. 6(c) illustrates luminance data of an illumination device, which is taken along a line A-A in FIG. 6(a), FIG. 6(d) illustrates luminance of an output image, which is taken along the line A-A in FIG. 6(a), and FIG. 6(e) is a view for explaining an image actually displayed on a display unit of the image processing device as the comparative example.

FIG. 7 is a block diagram illustrating a configuration of a display device according to Embodiment 2.

FIG. 8 is a block diagram illustrating a configuration of a display device according to Embodiment 3.

FIG. 9 is a plan view illustrating an example of a display unit provided in a display device according to Embodiment 4.

FIG. 10 illustrates an example of display by the display unit provided in the display device according to Embodiment 4.

FIGS. 11(a) to 11(d) are plan views each illustrating another example of the display unit provided in the display device according to Embodiment 4.

FIG. 12 illustrates an outline of processing in the display device according to Embodiment 4, in which FIG. 12(a) illustrates an input image, FIG. 12(b) illustrates a masking processed image, and FIG. 12(c) illustrates a state where the display unit displays an image.

FIG. 13 is a block diagram illustrating a configuration of a display device according to Embodiment 5.

FIG. 14 is a flowchart illustrating an example of processing in an image processing device according to Embodiment 5.

FIG. 15 illustrates an example of a state of display by a display unit provided in the display device according to Embodiment 5.

FIGS. 16(a) to 16(d) each illustrate an example of the state of display by the display unit provided in the display device according to Embodiment 5, which is different from the example illustrated in FIG. 15.

FIG. 17 is a block diagram illustrating a configuration of a display device according to Modified example 1 of Embodiment 5.

FIG. 18 is a block diagram illustrating a configuration of a display device according to Modified example 2 of Embodiment 5.

FIG. 19 is a view for explaining Modified example 3 of Embodiment 5.

FIG. 20 is a plan view illustrating a shape of a display unit provided in a display device according to Embodiment 6.

FIG. 21 is a block diagram illustrating a configuration of a display device according to Embodiment 7.

### DESCRIPTION OF EMBODIMENTS

### Embodiment 1

An embodiment of the disclosure will be described below in detail.

### (Outline of Display Device 1)

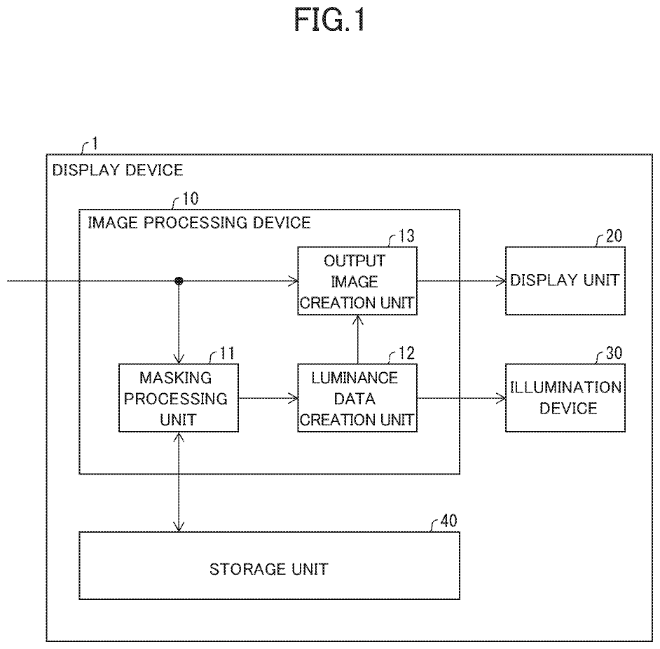

FIG. 1 is a block diagram illustrating a configuration of a display device 1 according to the present embodiment. As illustrated in FIG. 1, the display device 1 includes an image processing device 10, a display unit 20, an illumination device 30, and a storage unit 40.

The display unit 20 is a liquid crystal display panel (display panel) having a display region in a nonrectangular shape. The display region is a region in which display by the display unit 20 is visually recognized and the display unit 20 itself in a nonrectangular shape may have a nonrectangular shape or a region in which the display is able to be visually recognized may have a nonrectangular shape by shielding a part of the display unit 20 in a rectangular shape. In the present embodiment, the display unit 20 in a trapezoid shape is provided and a display region in a trapezoid shape is formed by the display unit 20 itself. Note that, the display unit 20 may be a display panel of a non emissive type that controls transmission of light from the illumination device 30 and a liquid crystal display panel is provided in the present embodiment.

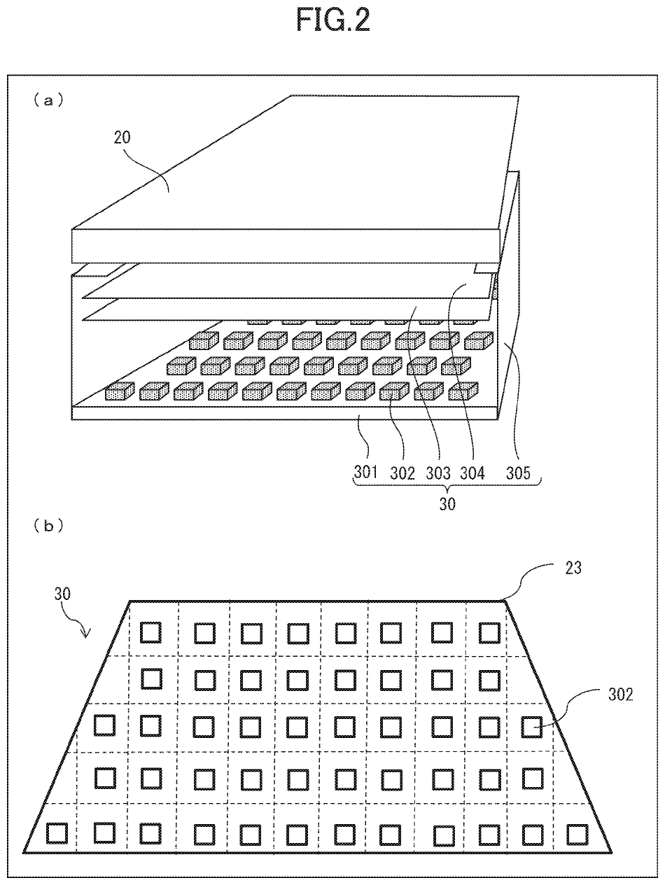

FIG. 2(a) illustrates an inside configuration of the display device 1. FIG. 2(b) illustrates a configuration of the illumination device 30. As illustrated in FIG. 2(a), the illumination device 30 is a backlight device that includes a substrate 301, a plurality of light sources 302 that are arranged on the substrate 301 and illuminate the display unit 20 with light, a diffuser 303, an optical sheet 304, and a housing 305 that accommodates the substrate 301, the light sources 302, the diffuser 303, and the optical sheet 304. As the light sources 302, for example, light emitting diodes (LEDs) are able to be used. The diffuser 303 is arranged above the light sources 302 and diffuses light, which is emitted from the light sources 302, so that backlight light is uniform light in a plane. The optical sheet 304 is constituted by a plurality of sheets arranged above the diffuser 303. Each of the plurality of sheets has a function of diffusing light, a condensing function, a function of enhancing light use efficiency, or the like. Moreover, in the illumination device 30, a light-emitting surface 23 matching the display region of the display unit 20 is constituted by the plurality of light sources 302. As illustrated in broken line parts of FIG. 2(b), the light-emitting surface 23 has a plurality of regions obtained by division for each of the light sources 302 and allows adjustment of luminance for each of the regions. Specifically, the illumination device 30 adjusts the luminance of each of the regions on the basis of luminance data created by a luminance data creation unit 12. In the present embodiment, a shape of the light-emitting surface 23 is a trapezoid similar to the shape of the display unit 20 and the light sources 302 are disposed correspondingly to a whole of the display unit 20.

The storage unit 40 stores information needed for processing by the image processing device 10. The storage unit 40 stores, for example, information indicating the shape of the display region of the display unit 20. Moreover, the storage unit 40 may store an incorporated image that is an image prepared in advance and having a shape corresponding to the shape of the display region or at least a part of the shape of the display region. Note that, the display device 1 may not necessarily include the storage unit 40 and may include a communication unit that communicates with a storage device provided outside in a wireless or wired manner.

### (Configuration of Image Processing Device 10)

The image processing device 10 includes a masking processing unit 11, the luminance data creation unit 12, and an output image creation unit 13. An input image input to the image processing device 10 is an image input from outside the display device 1 and is an image whose shape is different from the shape of the display region of the display device 1 and is rectangular, for example.

The masking processing unit 11 performs masking processing for a masking processing region that is a region other than the display region of the display unit 20 in the input image, and thereby generates a masking processed image. The masking processing unit 11 outputs the generated masking processed image to the luminance data creation unit 12.

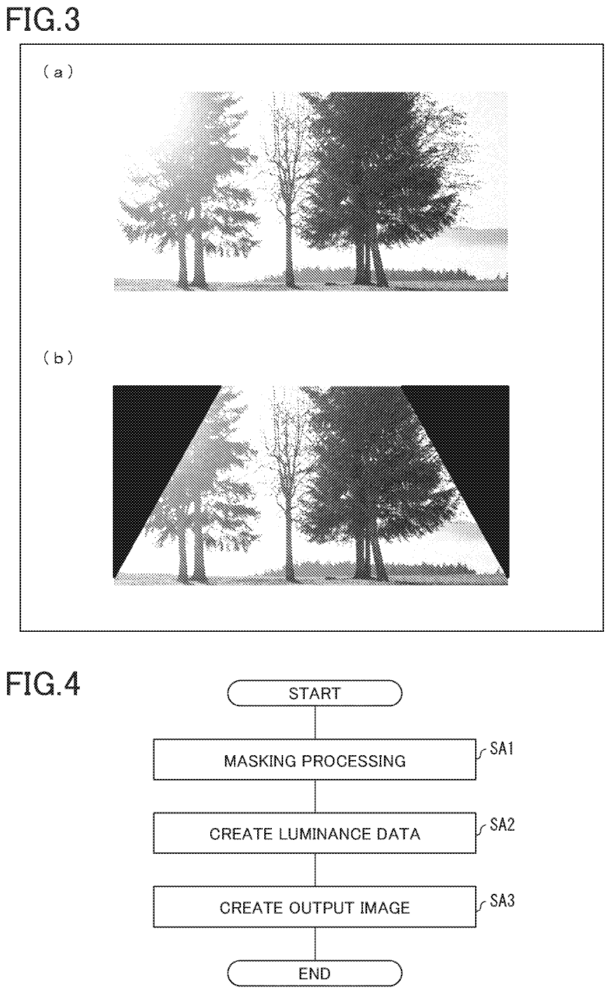

FIG. 3 illustrates processing by the masking processing unit 11, in which FIG. 3(a) illustrates an input image and FIG. 3(b) illustrates a masking processed image. As illustrated in FIG. 3(a), the input image is an image in a rectangular shape and has a region, in which luminance is high, in a vicinity of one corner.

Meanwhile, as described above, the display unit 20 of the present embodiment has the display region in the trapezoid shape. Thus, the masking processing unit 11 performs masking of the input image so as to match the shape of the display region and generates a masking processed image in a trapezoid shape as illustrated in FIG. 3(b). At this time, the aforementioned region in which luminance is high is out of a range of the display region of the display unit 20 and is thus not included in the masking processed image. Note that, when the display unit 20 has the display region in a nonrectangular shape other than the trapezoid shape, the masking processing unit 11 performs masking of the input image so as to match the shape of the display region.

On the basis of the masking processed image generated by the masking processing unit 11, the luminance data creation unit 12 creates luminance data, which indicates luminance of each of the regions of the light-emitting surface 23 of the illumination device 30 when an output image corresponding to the input image is displayed. In the present embodiment, the luminance data creation unit 12 creates the luminance data on the basis of a white luminance value of the masking processed image. As a method of creating the luminance data, a known method as described in PTL 1, for example, is able to be used. Moreover, the luminance data creation unit 12 outputs the created luminance data to the output image creation unit 13 and the illumination device 30.

The output image creation unit 13 creates an output image on the basis of the luminance data created by the luminance data creation unit 12 and the input image. As a method of creating the output image, a known method as described in PTL 1, for example, is able to be used. The output image created by the output image creation unit 13 is linked with the luminance data. In other words, the output image creation unit 13 integrates the luminance data created by the luminance data creation unit 12 and the input image. The output image creation unit 13 outputs the created output image to the display unit 20.

FIG. 4 is a flowchart illustrating an example of an image processing method in the image processing device 10. As illustrated in FIG. 4, in the image processing device 10, the masking processing unit 11 performs masking processing for an input image and generates a masking processed image (SA1, masking processing step). The luminance data creation unit 12 creates luminance data on the basis of the masking processed image (SA2, luminance data creation step). The output image creation unit 13 creates an output image on the basis of the luminance data and the input image (SA3, output image creation step).

### COMPARATIVE EXAMPLE

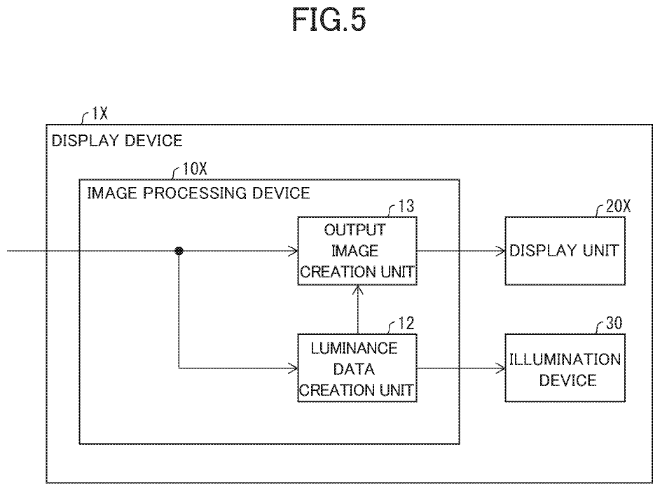

FIG. 5 illustrates a configuration of a display device 1X as a comparative example. As illustrated in FIG. 5, the display device 1X is different from the display device 1 in terms of including an image processing device 10X instead of the image processing device 10. The image processing device 10X is different from the image processing device 10 in terms of not including the masking processing unit 11. Accordingly, in the image processing device 10X, luminance data is created on the basis of an input image not subjected to masking processing.

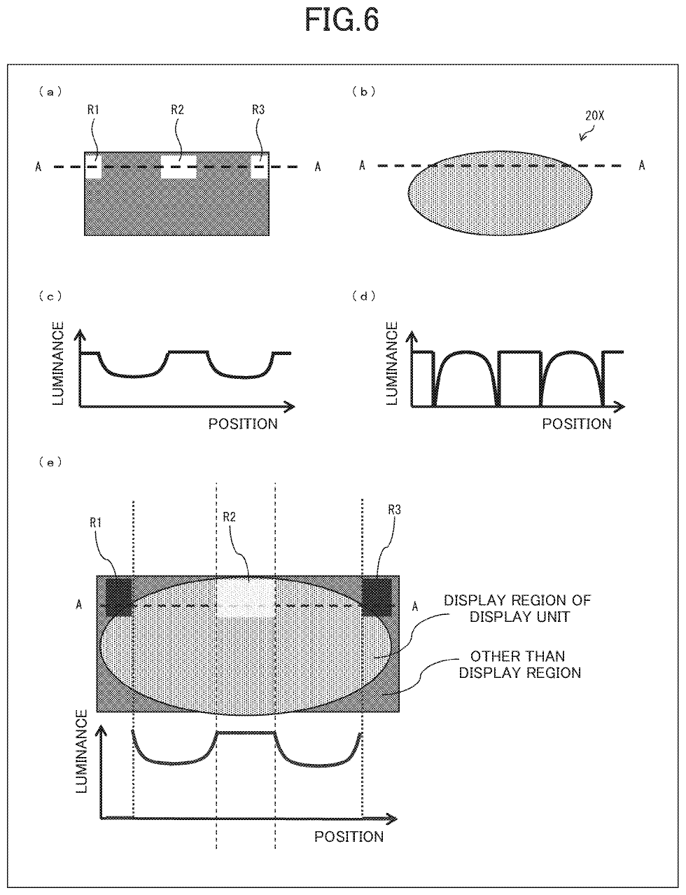

FIG. 6 is a view for explaining luminance data in the image processing device 10X, in which FIG. 6(a) illustrates an example of an input image, FIG. 6(b) illustrates a shape of a display region of a display unit 20X, FIG. 6(c) illustrates luminance data of the illumination device 30, which is taken along a line A-A in FIG. 6(a), FIG. 6(d) illustrates luminance data of an output image, which is taken along the line A-A in FIG. 6(a), and FIG. 6(e) is a view for explaining an image actually displayed on the display unit 20X.

As illustrated in FIG. 6(a), when local dimming is performed in the display device 1X, luminance data is created on the basis of a display content of an input image in a rectangular shape. In the created luminance data, a bright region that is a bright region of a picture image exists. In the present comparative example, bright regions R1, R2, and R3 exist only in both ends and a center of one side. Description will be given below for a case where such an input image is displayed on the display unit 20X having a display region in an elliptical shape as illustrated in FIG. 6(b).

In the luminance data of the input image, luminance of regions corresponding to the bright regions R1 to R3 is high and luminance of the other region is low as illustrated in

FIG. 6(c). Note that, in a vicinity of the bright regions R1 to R3, a halo phenomenon is caused due to characteristics of the light sources of the illumination device 30, so that luminance becomes high. Thus, in order to alleviate the halo phenomenon, the output image creation unit 13 creates an image, in which the luminance in the vicinity the bright regions R1 to R3 is reduced, as the output image as illustrated in FIG. 6(d).

However, neither regions corresponding to the bright regions R1 and R3 nor light sources 302 corresponding to the bright regions exist in the display unit 20X. Thus, luminance in a vicinity of regions corresponding to the bright regions R1 and R3 in actual luminance distribution in the illumination device 30 is lower than that in distribution of the luminance data illustrated in FIG. 6(c). Thus, when an image is displayed with the luminance distribution illustrated in FIG. 6(d) in the display device 1X, the bright regions R1 and R3 in the displayed image are displayed to be dark as illustrated in FIG. 6(e). When the bright regions R1 and R3 are displayed to be dark, a vicinity of the bright regions R1 and R3 is displayed to be darker than an original input image. Thus, deterioration in image quality of the displayed image is caused in the display device 1X.

### (Effect)

According to the image processing device 10 of the present embodiment, the masking processing unit 11 generates a masking processed image. When an input image is an image having the bright regions R1 to R3 as illustrated in FIG. 6(a) and the display region of the display device 1 has the elliptical shape as illustrated in FIG. 6(b), the bright regions R1 and R3 in the masking processed image are in a masked state. Thus, the luminance data creation unit 12 of the image processing device 10 creates luminance data so that the bright regions R1 and R3 are not included. Specifically, the luminance data creation unit 12 creates luminance data in which luminance of a region corresponding to the bright region R2 is high and the luminance is monotonously reduced as being far from the bright region R2. Moreover, the output image creation unit 13 creates an output image in which luminance only in a vicinity of the bright region R2 is low.

Thus, according to the image processing device 10, deterioration in image quality in a display device having a display region in a nonrectangular shape is able to be suppressed.

Note that, though the display unit 20 of the display device 1 described above has the trapezoid shape, specific examples of a shape other than the trapezoid shape include a triangular shape, a circular shape, an elliptical shape, a hexagonal shape, and the like. In addition, the display device 1 may include, as the illumination device 30, an edge light device that illuminates the display unit 20 with light from an end of the display unit 20 or a front light device that illuminates the display unit 20 with light from a front surface of the display unit 20, instead of the backlight device. Moreover, the shape of the light-emitting surface 23 is only required to be a shape corresponding to the display region of the display unit 20 and is not limited to the trapezoid shape.

### MODIFIED EXAMPLE

A modified example of the display device 1 will be described below. A display device according to the present modified example includes, as an illumination device, LEDs that emit light in respective colors of red (R), green (G), and blue (B) for each of regions. In the display device including such an illumination device, a luminance data creation unit divides a masking processed image into an R image, a G image, and a B image, and creates luminance data for each of the regions of the respective LEDs on the basis of pixel values of pixels constituting the respective images.

### Embodiment 2

Another embodiment of the disclosure will be described below. Note that, for convenience of description, a member having the same function as the member described in the aforementioned embodiment will be given the same reference sign and description thereof will not be repeated.

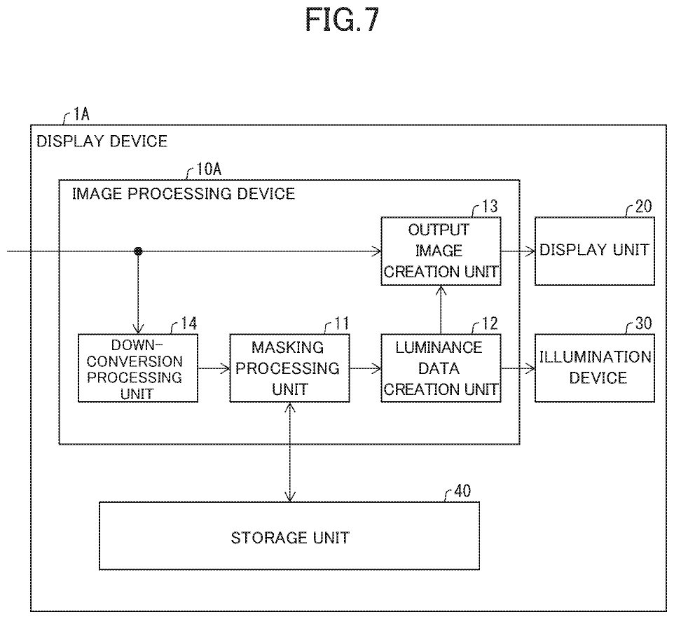

FIG. 7 is a block diagram illustrating a configuration of a display device 1A according to the present embodiment. As illustrated in FIG. 7, the display device 1A is different from the display device 1 in terms of including an image processing device 10A instead of the image processing device 10. The image processing device 10A includes a down-conversion processing unit 14 in a former stage of the masking processing unit 11, in addition to the respective components of the image processing device 10.

The down-conversion processing unit 14 performs processing (down-conversion processing) of reducing a size of an input image. The down-conversion processing unit 14 down-converts, for example, an input image having a 4K2K size into a 2K1K size. However, the down-conversion by the down-conversion processing unit 14 is not limited to such an example. The down-conversion processing unit 14 outputs the reduced input image to the masking processing unit 11.

The masking processing unit 11 performs masking processing for the input image reduced by the down-conversion processing unit 14. The luminance data creation unit 12 creates luminance data on the basis of a luminance value of the image that is reduced and subjected to the masking processing.

In the image processing device 10A, the masking processing unit 11 performs masking processing for the input image that is subjected to the down-conversion processing by the down-conversion processing unit 14. Accordingly, the number of pixels to be subjected to the masking processing in the masking processing unit 11 is able to be reduced, so that a processing amount in the masking processing unit 11 is reduced and a circuit size is able to be reduced. For example, when the down-conversion processing unit 14 down-converts a size of the input image into one quarter (that is, down-converts each of vertical and horizontal sizes into a half), both the processing amount of the masking processing unit 11 and the circuit size are also able to be made one quarter as compared to a case where down-conversion is not performed.

Moreover, in the image processing device 10A, the luminance data creation unit 12 creates luminance data on the basis of a masking processed image that is down-converted and then subjected to the masking processing. In this case, the number of pixels of the masking processed image is also reduced as compared to a case where down-conversion processing is not performed for the input image, so that a processing amount in the luminance data creation unit 12 is also reduced.

Note that, in an example illustrated in FIG. 7, the image processing device 10A includes the down-conversion processing unit 14 in the former stage of the masking processing unit 11. However, the image processing device 10A may include the down-conversion processing unit 14 in a latter stage of the masking processing unit 11. That is, either the down-conversion processing or the masking processing may be performed first. When the down-conversion processing is performed after the masking processing, however, the processing amount in the luminance data creation unit 12 is reduced, but the processing amount in the masking processing unit 11 is not reduced. Thus, from a viewpoint of reducing the processing amount, the image processing device 10A preferably includes the down-conversion processing unit 14 in the former stage of the masking processing unit 11.

### Embodiment 3

Hereinafter, another embodiment of the disclosure will be described below.

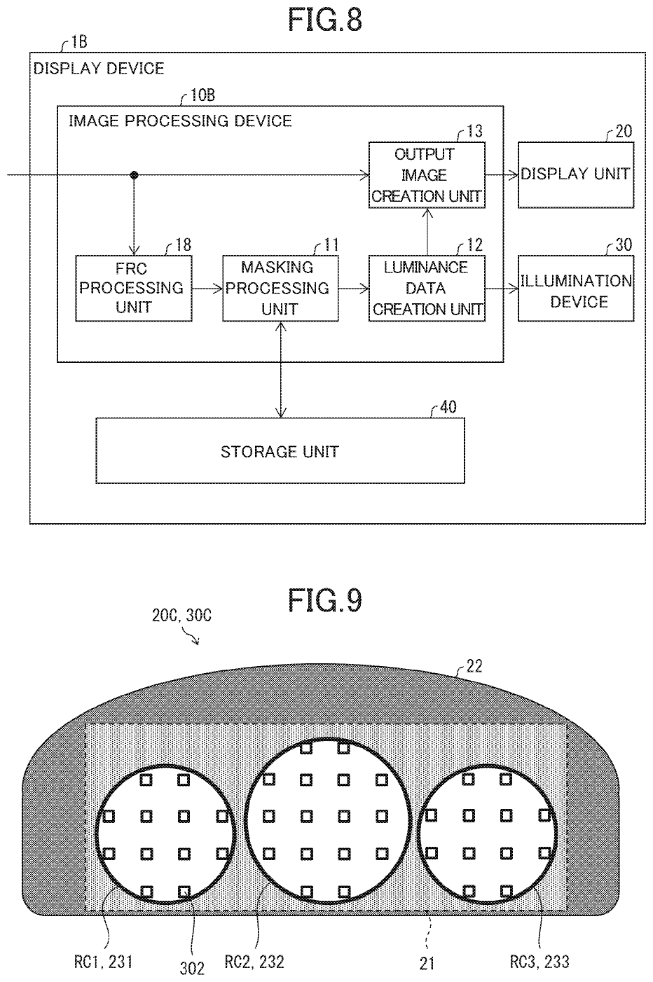

FIG. 8 is a block diagram illustrating a configuration of a display device 1B according to the present embodiment. As illustrated in FIG. 8, the display device 1B is different from the display device 1 in terms of including an image processing device 10B instead of the image processing device 10. The image processing device 10B includes a frame rate change (FRC) processing unit 18, which performs FRC processing, in a former stage of the masking processing unit 11.

The FRC processing unit 18 performs processing of converting a frame rate of an input image into a different frame rate. A frame rate of an output image may be higher or lower than the frame rate of the input image. As an example, when the frame rate of the input image is 60 frame per second (fps), processing of conversion into 120 fps is performed.

In this manner, in the image processing device according to the present embodiment, the output image subjected to both the masking processing and the FRC processing is able to be output. Note that, in an example illustrated in FIG. 8, the image processing device 10B includes the FRC processing unit 18 in the former stage of the masking processing unit 11. However, the image processing device 10B may include the FRC processing unit 18 in a latter stage of the masking processing unit 11.

### Embodiment 4

Hereinafter, another embodiment of the disclosure will be described below. A display device according to the present embodiment has a similar configuration to that of the display device 1 other than including a display unit 20C and an illumination device 30C instead of the display unit 20 and the illumination device 30. Therefore, a similar reference sign to that of the display device 1 is assigned to a member other than the display unit 20C in the following description.

FIG. 9 is a plan view illustrating an example of the display unit 20C provided in the display device according to the present embodiment. In an example illustrated in FIG. 9, the display unit 20C has a rectangular shape. Specifically, the display unit 20C includes a liquid crystal panel 21 in a rectangular shape and a frame 22. The liquid crystal panel 21 is shielded by the frame 22 so that a part thereof is not visually recognized. Thereby, the liquid crystal panel 21 has three display regions RC1, RC2, and RC3 in a circular shape. In other words, the frame 22 shields a region of the display unit 20C other than the display regions RC1 to RC3 in a nonrectangular shape.

Moreover, the illumination device 30C according to the present embodiment includes light-emitting surfaces 231, 232, and 233 respectively corresponding to the display regions RC1, RC2, and RC3. The light-emitting surfaces 231, 232, and 233 respectively emit light to the display regions RC1, RC2, and RC3.

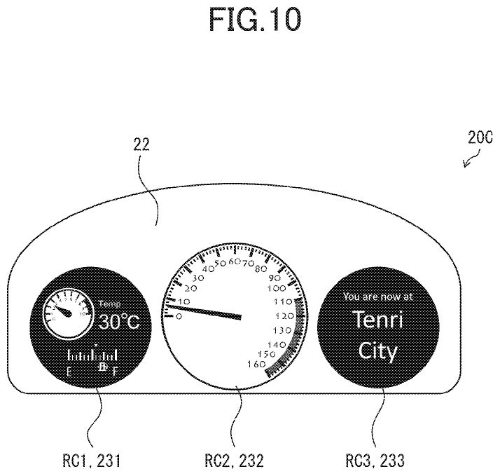

FIG. 10 illustrates an example of display by the display unit 20C. The display unit 20C is a display unit provided, for example, in a console of a vehicle and is able to display information about the vehicle in each of the display regions as illustrated in FIG. 10 and also able to display only a portion corresponding to each of the display regions in a single input image.

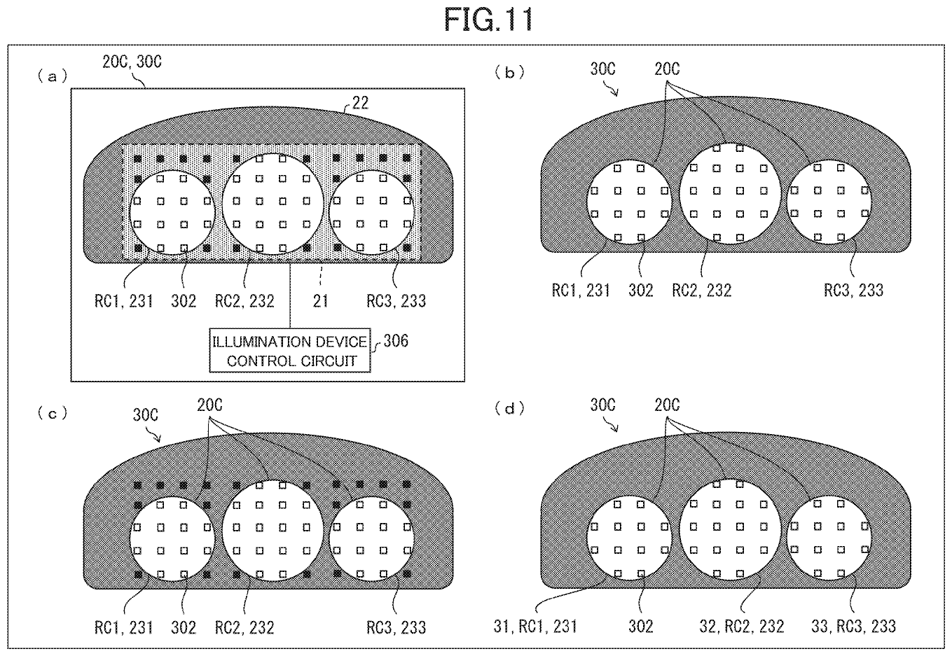

FIGS. 11(a) to 11(d) are plan views each illustrating another example of the display unit 20C. The illumination device 30C includes (i) a form in which a plurality of light sources 302 are provided only in regions facing the display regions RC1, RC2, and RC3 and (ii) a form in which light sources 302 are provided in an entire region facing a whole of the display unit 20C but a light source 302 positioned in a region other than the regions facing the display regions RC1, RC2, and RC3 is not turned on.

In (i) described above, for example, as illustrated in FIG. 9, the light sources 302 are disposed correspondingly to the three display regions RC1, RC2, and RC3 in the circular shape. Moreover, in (ii) described above, for example, as illustrated in FIG. 11(a), the light sources 302 are disposed in a region facing a whole of the display unit 20, but control is performed so that only the light sources 302 disposed in the regions corresponding to the display regions RC1, RC2, and RC3 are turned on. In other words, the light sources 302 disposed in a region overlapped with the frame 22 are turned off. Moreover, in an example illustrated in FIG. 11(a), the illumination device 30C further includes an illumination device control circuit 306 that controls lighting of the light sources 302. In the example, a form in which the light sources 302 disposed in the region overlapped with the frame 22 are turned off means that the illumination device control circuit 306 performs control so that the light sources 302 existing in a region other than the light-emitting surfaces 231 to 233 are not turned on. In other words, the light sources 302 are controlled by the illumination device control circuit 306 so that only the light sources 302 existing in the regions corresponding to the display regions RC1, RC2, and RC3 are turned on. Note that, the illumination device 30C does not necessarily include the illumination device control circuit 306. When the illumination device 30C does not include the illumination device control circuit 306, for example, a state where the light sources 302 arranged in the region other than the light-emitting surfaces 231 to 233 are not turned on may be provided by cutting wiring thereof or providing no wiring thereof.

Moreover, in the examples illustrated in FIGS. 9 and 11(a), though the display unit 20C in the rectangular shape includes the frame 22 so that the display regions RC1 to RC3 in the nonrectangular shape are formed, the display unit 20C may be a display unit in a nonrectangular shape as illustrated in FIGS. 11(b) and 11(c). Also in this case, the light sources 302 may be disposed only in the regions facing the display regions RC1 to RC3 as illustrated in FIG. 11(b) or may be disposed also in a region other than the regions facing the display regions RC1 to RC3 as illustrated in FIG. 11(c).

Also in such a display unit 20C, since no light source 302 exists in a part other than a back of the display regions RC1, RC2, and RC3 or the light sources 302 in the back of the display regions RC1, RC2, and RC3 are not turned on, when an input image is tried to be displayed, deterioration in image quality of the image may be caused similarly to the display device 1. Thus, in the display device of the present embodiment, information indicating positions and shapes of the display regions RC1, RC2, and RC3 is stored in the storage unit 40. On the basis of the information, the masking processing unit 11 generates a masking processed image obtained by performing masking processing for a region of the input image, which is overlapped with the frame 22.

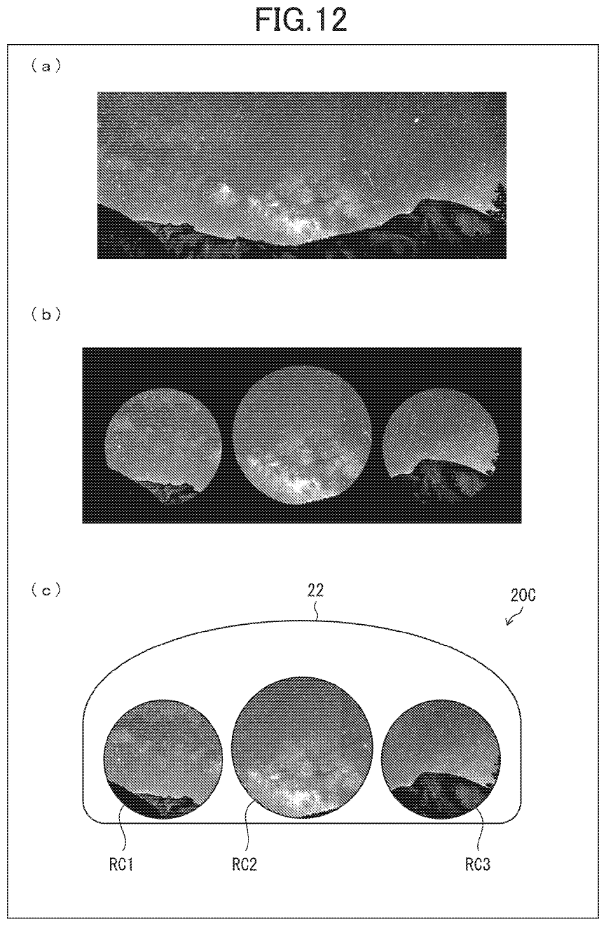

FIG. 12 illustrates an outline of processing in the display device according to the present embodiment, in which FIG. 12(a) illustrates an input image, FIG. 12(b) illustrates a masking processed image, and FIG. 12(c) illustrates a state where the display unit 20C displays an image. As illustrated in FIG. 12(a), the input image has a rectangular shape. The masking processing unit 11 performs masking processing for the region other than the regions corresponding to the display regions RC1 to RC3 as illustrated in FIG. 12(b) and generates the masking processed image. The luminance data creation unit 12 creates luminance data on the basis of the masking processed image. The output image creation unit 13 creates an output image on the basis of the luminance data and the input image. The created output image is displayed on the display unit 20C as illustrated in FIG. 12(c).

In this manner, the display device according to the present embodiment includes the image processing device 10 similar to that of Embodiment 1, and is thus able to display an image in each of the plurality of display regions RC1 to RC3 in the nonrectangular shape without deterioration in image quality.

Note that, all the display regions RC1 to RC3 have the circular shape in the present embodiment, but may have, for example, an elliptical shape, a semicircular shape, or another shape. Moreover, shapes of the plurality of display regions may be different from each other. Further, in an aspect of the disclosure, the number of display regions may be two or may be four or more.

Though a form in which the single illumination device 30C includes the light-emitting surfaces 231, 232, and 233 has been described in the present embodiment, a plurality of illumination devices 31 to 33 respectively and independently corresponding to the display regions RC1 to RC3 as illustrated in FIG. 11(d) may be used. In this case, an illumination device control circuit 306 provided in any of the illumination devices 31 to 33 may integrally control lighting of the plurality of illumination devices 31 to 33.

### Embodiment 5

Hereinafter, another embodiment of the disclosure will be described below.

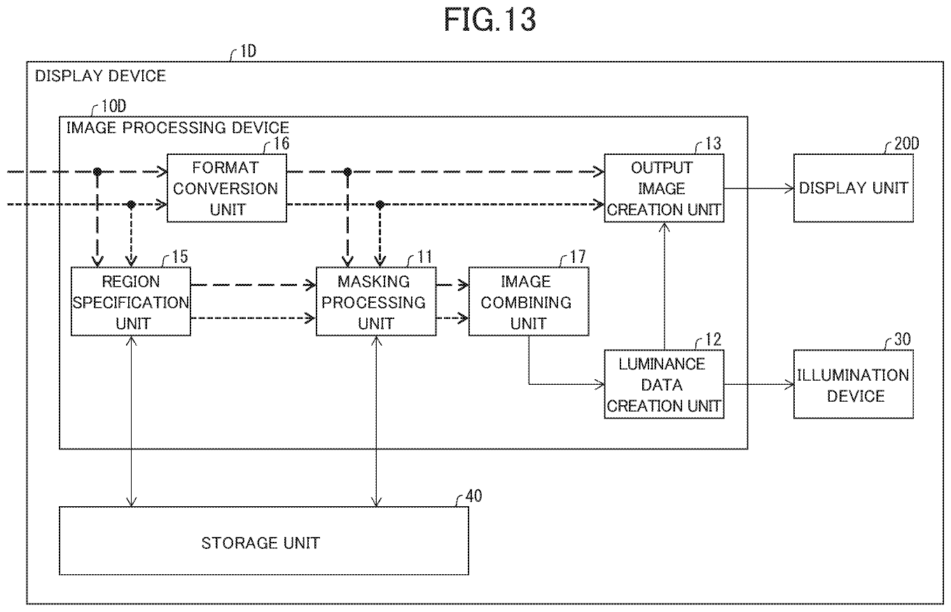

FIG. 13 is a block diagram illustrating a configuration of a display device 1D according to the present embodiment. As illustrated in FIG. 13, the display device 1D is different from the display device 1 in terms of including an image processing device 10D and a display unit 20D instead of the image processing device 10 and the display unit 20, respectively. The image processing device 10D includes a region specification unit 15, a format conversion unit 16, and an image combining unit 17, in addition to the configuration of the image processing device 10.

In accordance with relative display positions of a plurality of images including an input image, the region specification unit 15 specifies a region other than a display region in the input image as a masking processing region to be subjected to masking processing. A plurality of images are input to the region specification unit 15. An image input to the region specification unit 15 may be an input image as described above or an incorporated image. The incorporated image may be an image stored in the storage unit 40, for example, as described above. In an example illustrated in FIG. 13, two types of input images are input to the region specification unit 15. However, when one or more incorporated images are input to the region specification unit 15, the number of input images input to the region specification unit 15 may be only one. Moreover, the relative display positions of the plurality of images may be stored in the storage unit 40 in advance or may be able to be set by the user with an input device (not illustrated) that receives an input by the user. The region specification unit 15 outputs information indicating the masking processing region to the masking processing unit 11.

When a plurality of input images are input to the region specification unit 15, in accordance with relative display positions of the plurality of input images, the region specification unit 15 specifies a region other than a display region in each of the input images as a masking processing region. On the other hand, when at least one input image and an incorporated image are input to the region specification unit 15, the region specification unit 15 specifies a region other than a display region in the input image as a masking processing region in accordance with relative display positions of the input image and the incorporated image that are input. Note that, the incorporated image has a shape corresponding to at least a part of a shape of the display region and thus does not need to be subjected to masking processing.

The format conversion unit 16 changes a format of the input image. Specifically, the format conversion unit 16 performs up-conversion or down-conversion to adjust resolution of the input image to resolution of the display unit 20D or a size of the display region. Similarly to the region specification unit 15, a plurality of images are input also to the format conversion unit 16. The format conversion unit 16 outputs each of the input images after being subjected to format conversion to the masking processing unit 11 and the output image creation unit 13. The output image creation unit 13 generates an output image on the basis of (i) luminance data created from each of masking processed images and (ii) an image when each of the input images is displayed at each of display positions. However, the image processing device 10D may not necessarily include the format conversion unit 16.

Note that, when the format conversion unit 16 performs down-conversion processing for the input image, processing in the format conversion unit 16 is similar to the aforementioned processing in the down-conversion processing unit 14. However, the down-conversion processing unit 14 down-converts an image to be subjected to masking processing by the masking processing unit 11. On the other hand, the format conversion unit 16 down-converts the input image used for the output image creation unit 13 to create an output image. In other words, while the down-conversion processing by the down-conversion processing unit 14 is not reflected to the output image, the down-conversion processing by the format conversion unit 16 is reflected to the output image.

In the image processing device 10D, the masking processing unit 11 performs masking processing of the masking processing region, which is specified by the region specification unit 15, in each of the input images subjected to format conversion. Here, a size of the masking processing region specified by the region specification unit 15 is a size corresponding to a size of the input image before being subjected to format conversion. Thus, the masking processing unit 11 creates the masking processed image after converting the size of the masking processing region specified by the region specification unit 15 so as to correspond to a size of the input image after being subjected to format conversion. The masking processing unit 11 outputs the masking processed image to the image combining unit 17. Note that, in the example illustrated in FIG. 13, the single masking processing unit 11 is configured to perform masking processing for a plurality of input images. However, the image processing device 10D may include a plurality of masking processing units corresponding to a plurality of input images.

The image combining unit 17 generates a combined image by combining a plurality of masking processed images. Alternatively, the image combining unit 17 generates a combined image by combining at least one masking processed image and an incorporated image. The luminance data creation unit 12 creates luminance data on the basis of the combined image and outputs the luminance data to the output image creation unit 13 and the illumination device 30. The output image creation unit 13 creates an output image on the basis of the luminance data created by the luminance data creation unit 12 and the input image subjected to format conversion by the format conversion unit 16. For creating the luminance data and the output image, a known method described in PTL 1, for example, is able to be used similarly to Embodiment 1.

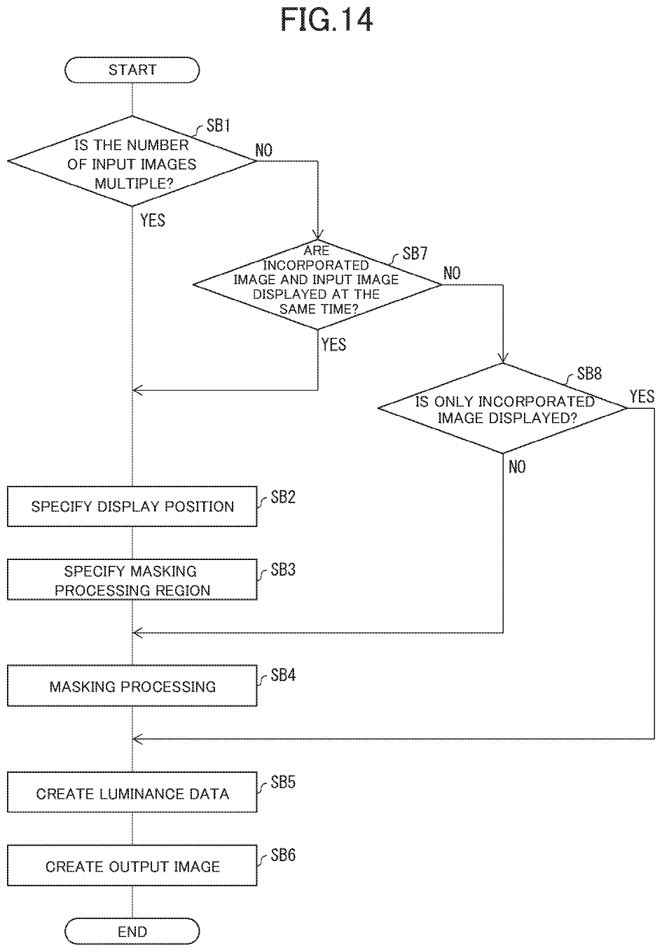

FIG. 14 is a flowchart illustrating an example of processing in the image processing device 10D. In the image processing device 10D, first, the region specification unit 15 determines whether or not the number of input images to be displayed at the same time is multiple (SB1). When the number of input images to be displayed at the same time is multiple (YES at SB1), the region specification unit 15 specifies a display position of each of them (SB2) and specifies a masking processing region (SB3).

On the basis of the specified masking processing region, the masking processing unit 11 performs masking processing and creates a masking processed image (SB4). The luminance data creation unit 12 creates luminance data on the basis of the masking processed image (SB5). Further, the output image creation unit 13 creates an output image on the basis of the luminance data and the input images subjected to format conversion (SB6).

On the other hand, when the number of input images is not multiple (NO at SB1), the region specification unit 15 determines whether or not an incorporated image and an input image are displayed at the same time (SB7). When the incorporated image and the input image are displayed at the same time (YES at SB7), the image processing device 10D performs processing of steps SB2 to SB6 for the input image.

When the incorporated image and the input image are not displayed at the same time (NO at SB7), the region specification unit 15 determines whether or not what is displayed is only the incorporated image (SB8). When what is displayed is not only the incorporated image (NO at SB8), that is, when what is displayed is only the input image, the image processing device 10D performs processing of step SB4 and subsequent processing for the input image. When what is displayed is only the incorporated image (YES at SB8), the image processing device 10D performs processing of step SB5 and subsequent processing for the incorporated image.

In this manner, in the image processing device 10D, the region specification unit 15 specifies a masking processing region in accordance with relative display positions of a plurality of images including an input image. Then, the masking processing unit 11 performs masking processing for the specified masking processing region. Thus, even when a plurality of images are displayed, the masking processing unit 11 is able to perform appropriate masking processing according to a display position of the input image.

Further, in the image processing device 10D, the image combining unit 17 combines the plurality of images including the input image. Then, the luminance data creation unit 12 creates luminance data on the basis of the combined image combined by the image combining unit 17. Thus, the luminance data creation unit 12 is able to create luminance data on the basis of the image that is subjected to appropriate masking processing and combined.

An example in which one input image and one incorporated image are displayed at the same time will be described below.

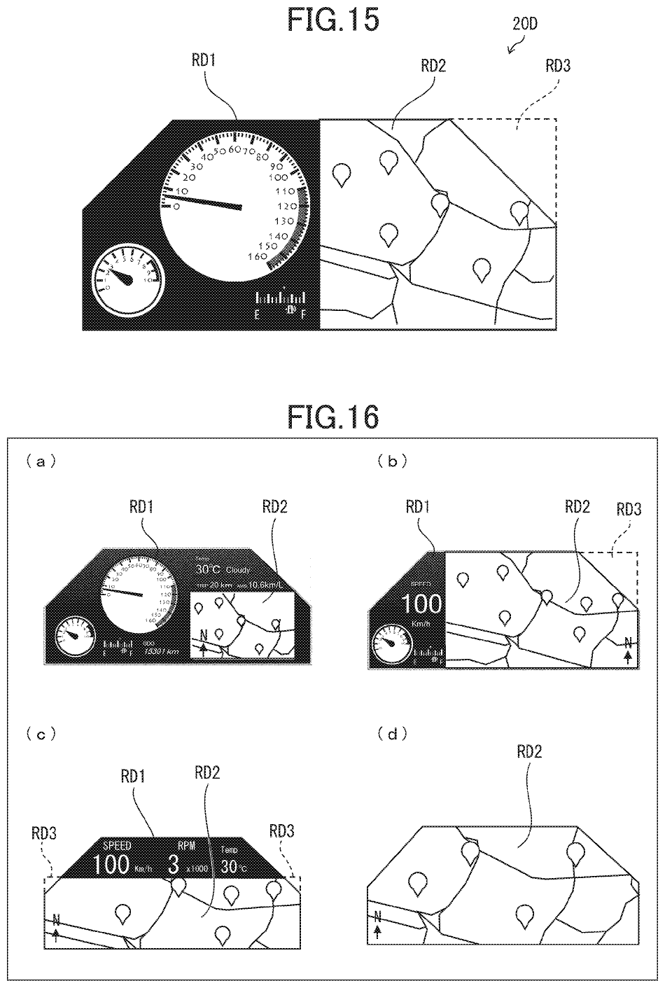

FIG. 15 illustrates an example of a state of display by the display unit 20D. As illustrated in FIG. 15, the display unit 20D has a display region that is formed so that both ends of one of long sides of a rectangular shape are cut. The display region of the display unit 20D is divided into a display region RD1 and a display region RD2. A meter image that is an incorporated image is displayed in the display region RD1. On the other hand, a navigation image that is an input image is displayed in the display region RD2.

In this case, the region specification unit 15 specifies a region other than a display region in the navigation image as a masking processing region in accordance with relative display positions of the meter image and the navigation image. In the example illustrated in FIG. 15, the region specification unit 15 specifies, as a masking processing region RD3, a region positioned outside the display region RD2 in the navigation image in a rectangular shape.

FIGS. 16(a) to 16(d) each illustrate an example of the state of display by the display unit 20D, which is different from the example illustrated in FIG. 15.

In the example illustrated in FIG. 16(a), a whole of the display region RD2 in which the navigation image is displayed is overlapped with the display region RD1 in which the meter image is displayed. In this case, only the meter image that is the incorporated image is in contact with an outer edge of the display unit 20D. As described above, the incorporated image has a shape matching the shape of the display region of the display unit 20D.

Therefore, in the example illustrated in FIG. 16(a), image quality is not lowered even when local dimming control is performed. Thus, when the whole of the display region in which the input image is displayed is overlapped with the display region in which the incorporated image is displayed, masking processing does not need to be performed.

In the examples illustrated in FIGS. 16(b) and 16(c), similarly to the example illustrated in FIG. 15, the display regions RD1 and RD2 are adjacent to each other. In these cases, the region specification unit 15 specifies the masking processing region RD3, in which masking processing is performed for the navigation image, in accordance with a shape of the display region RD2. The masking processing unit 11 performs masking processing for the navigation image on the basis of the masking processing region specified by the region specification unit 15.

In the example illustrated in FIG. 16(d), there is no display region RD1 in which the meter image is displayed, and a whole of the display region of the display unit 20D serves as the display region RD2 in which the navigation image is displayed. In this case, the region specification unit 15 does not specify a masking processing region in accordance with relative display positions of a plurality of input images. The masking processing unit 11 may perform masking processing on the basis of the shape of the display region of the display unit 20D, similarly to Embodiment 1.

Note that, in the present embodiment, the format conversion unit 16 receives an input of a plurality of images and converts formats of the plurality of images. However, in an aspect of the disclosure, the format conversion unit 16 may receive an input of a single image and convert a format of the image. Specifically, in the image processing device 10 illustrated in FIG. 1, for example, the format conversion unit 16 may be provided in a former stage of the output image creation unit 13.

### MODIFIED EXAMPLE 1

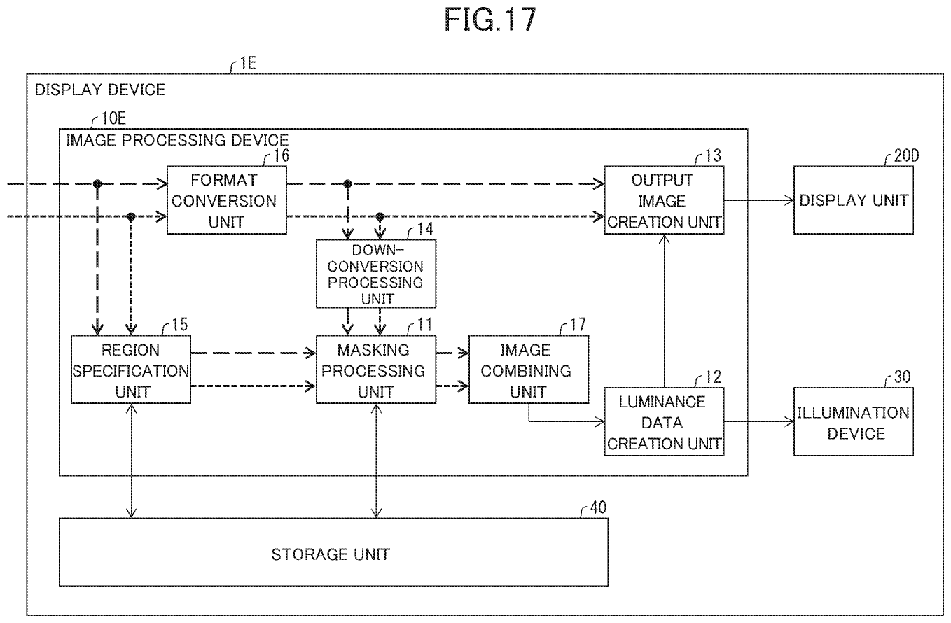

FIG. 17 is a block diagram illustrating a configuration of a display device 1E according to a modified example of the present embodiment. As illustrated in FIG. 17, the display device 1E is different from the display device 1D in terms of including an image processing device 10E instead of the image processing device 10D. The image processing device 10E includes the down-conversion processing unit 14 in addition to the configuration of the image processing device 10D.

The down-conversion processing unit 14 is provided between the format conversion unit 16 and the masking processing unit 11. Similarly to the display device 1A, also in the display device 1D, the masking processing unit 11 performs masking processing for an image subjected to down-conversion processing, so that a processing amount is able to be reduced.

### MODIFIED EXAMPLE 2

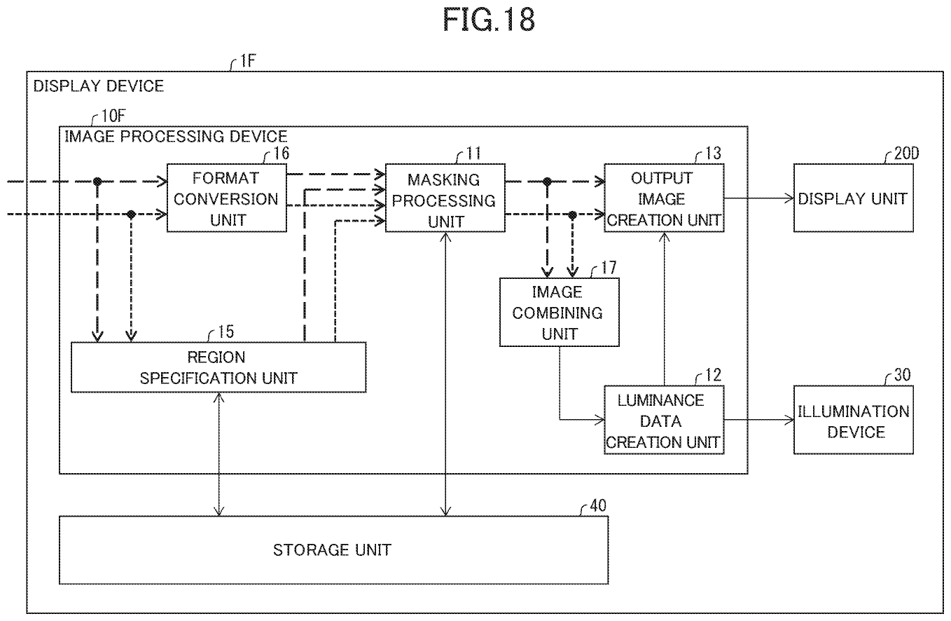

FIG. 18 is a block diagram illustrating a configuration of a display device 1F according to another modified example of the present embodiment. As illustrated in FIG. 18, the display device 1F is different from the display device 1D in terms of including an image processing device 10F instead of the image processing device 10D. The image processing device 10F is different from the image processing device 10D in that not an image converted by the format conversion unit 16 but a masking processed image subjected to masking processing in the masking processing unit 11 is output to the output image creation unit 13.

In this manner, the image processing device 10F in which the masking processed image is output to the output image creation unit 13 is also included in a scope of the image processing device of the present embodiment.

### MODIFIED EXAMPLE 3

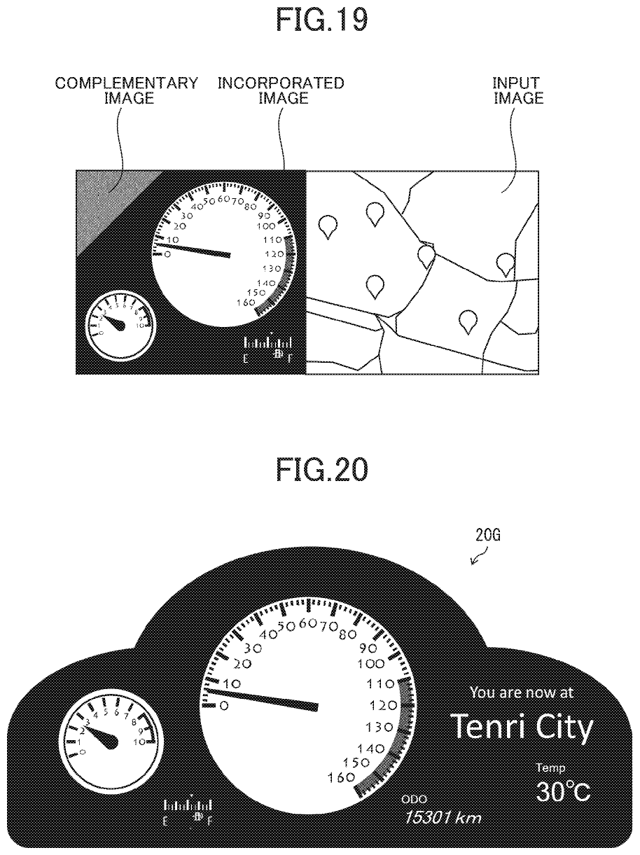

FIG. 19 is a view for explaining still another modified example of the present embodiment. In the present modified example, an image processing device performs masking processing after combining images earlier.

FIG. 19 illustrates an example of an image to be subjected to masking processing in the present modified example. In the present modified example, an input image and an incorporated image are combined before masking processing, and masking processing is performed for a combined image. In this case, a complementary image that complements the incorporated image is created so that the image to be subjected to the masking processing has a rectangular shape as illustrated in FIG. 19, and combined together with the input image and the incorporated image are. After that, a region to be subjected to the masking processing is specified.

That is, in the image processing device of the present modified example, in accordance with relative display positions of the input image and the incorporated image, the region specification unit 15 generates an image in a rectangular shape that includes the input image and the incorporated image. Further, in accordance with relative display positions of the input image and the incorporated image, the region specification unit 15 specifies a masking processing region in the image in the rectangular shape. Furthermore, format conversion by the format conversion unit 16 and/or down-conversion processing by the down-conversion processing unit 14 are/is performed for the image in the rectangular shape as needed. Such an image processing device is also able to display a plurality of images including the input image without deteriorating image quality.

### Embodiment 6

Hereinafter, another embodiment of the disclosure will be described below.

FIG. 20 is a plan view illustrating a shape of a display unit 20G provided in a display device according to the present embodiment. As illustrated in FIG. 20, the display unit 20G has a display region that is formed so that one of long sides of a rectangular shape is replaced with a line obtained by combining a plurality of curves that are projected outwardly and corners of ends of the other long side are further replaced with circular arcs.

Also when the display unit 20G has such a display region, by storing information indicating the shape of the display region in the storage unit 40 in advance, the image processing device 10 is able to suppress deterioration in image quality of an image displayed on the display unit 20G. That is, the masking processing unit 11 performs masking processing for an input image on the basis of the shape of the display region. The luminance data creation unit 12 creates luminance data indicating luminance distribution of illumination on the basis of a masking processed image. Further, the output image creation unit 13 creates an output image on the basis of the luminance data created by the luminance data creation unit 12 and the input image or the masking processed image.

Further, the shape of the display region of the display unit 20G may be any shape without being limited to an example of FIG. 20.

### Embodiment 7

Hereinafter, another embodiment of the disclosure will be described below.

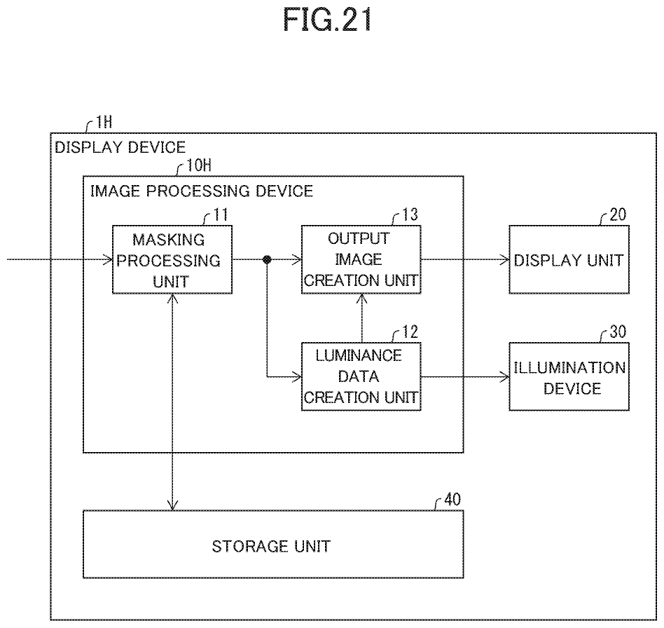

FIG. 21 is a block diagram illustrating a configuration of a display device 1H according to the present embodiment. As illustrated in FIG. 20, the display device 1H of the present embodiment is different from the display device 1 in terms of including an image processing device 10H instead of the image processing device 10. The image processing device 10H is different from the image processing device 10 in that the output image creation unit 13 is positioned in the latter stage of the masking processing unit 11.

Thus, in the display device 1H, the output image creation unit 13 creates an output image on the basis of luminance data and a masking processed image. Such a display device 1H also exerts an effect similar to that of the display device 1. Note that, also in each another embodiment described above, the output image creation unit 13 may create an output image on the basis of luminance data and a masking processed image.

### [Implementation Example by Software]

The image processing devices 10, 10A, 10D, 10E, 10F, and 10H (particularly, the masking processing unit 11, the luminance data creation unit 12, the output image creation unit 13, the down-conversion processing unit 14, the region specification unit 15, the format conversion unit 16, and the image combining unit 17) may be implemented by a logic circuit (hardware) formed in an integrated circuit (IC chip) or the like or may be implemented by software.

In the latter case, each of the image processing devices 10, 10A, 10D, 10E, 10F, and 10H includes a computer that executes a command of a program that is software implementing each function. The computer includes, for example, at least one processor (control device) and at least one computer-readable recording medium that stores the program. When the processor reads the program from the recording medium and executes the program in the computer, an object of an aspect the disclosure is achieved. As the processor, for example, a central processing unit (CPU) is able to be used. As the recording medium, a “non-transitory tangible medium”, for example, such as a tape, a disk, a card, a semiconductor memory, or a programmable logic circuit is able to be used in addition to a read only memory (ROM) and the like. Moreover, a random access memory (RAM), which develops the program, or the like may be further included. Further, the program may be supplied to the computer via any transmission medium (such as a communication network or a broadcast wave) which allows the program to be transmitted. Note that, an aspect of the disclosure can also be implemented in a form of a data signal in which the program is embodied through electronic transmission and which is embedded in a carrier wave.

### [Conclusion]

An image processing device according to an aspect 1 of the disclosure is an image processing device that generates an output image displayed on a display device that controls lighting of a plurality of light sources corresponding to a display region in a nonrectangular shape, and the image processing device includes: a masking processing unit that uses a region other than the display region in an input image, which is input from outside, as a masking processing region to perform masking processing for the masking processing region and generates a masking processed image; a luminance data creation unit that creates luminance data, which indicates luminance of the plurality of light sources when an output image corresponding to the input image is displayed, on a basis of the masking processed image; and an output image creation unit that creates the output image on a basis of the luminance data and the input image or the masking processed image.

According to the aforementioned configuration, the masking processing unit performs the masking processing for the masking processing region and generates the masking processed image. The luminance data creation unit creates the luminance data, which indicates the luminance of the light sources when the output image corresponding to the input image is displayed, on the basis of the masking processed image. The output image creation unit creates the output image on the basis of the luminance data and the input image or the masking processed image.

Accordingly, since the masked region of the input image does not affect the luminance data, deterioration in image quality caused by the region is suppressed.

It is preferable that the image processing device according to an aspect 2 of the disclosure further includes a down-conversion processing unit that reduces a size of the input image, in which the masking processing unit performs the masking processing for the input image that is reduced by the down-conversion processing unit, in the aspect 1.

According to the aforementioned configuration, the masking processing unit performs the masking processing for the input image that is reduced. Thus, a processing amount in the masking processing unit is able to be reduced.

It is preferable that the image processing device according to an aspect 3 of the disclosure further includes a format conversion unit that converts a format of the input image, in which the output image creation unit creates the output image on a basis of the luminance data and the input image the format of which is converted by the format conversion unit, in the aspect 1 or 2.

According to the aforementioned configuration, by converting the format of the input image by the format conversion unit, even when the format of the input image is different from a format of the display device, an image is able to be appropriately displayed by the display device.

It is preferable that the image processing device according to an aspect 4 of the disclosure further includes a region specification unit that specifies, in accordance with (1) relative display positions of a plurality of input images, each of which is the input image input from outside, or (2) relative display positions of at least one of the input images and an incorporated image serving as an image that is prepared in advance and having a shape corresponding to at least a part of a shape of the display region, a region other than the display region in the input image as the masking processing region, in any of the aspects 1 to 3.

According to the aforementioned configuration, the region specification unit specifies the masking processing region in accordance with a relative display position of an input image. The masking processing unit performs the masking processing for the masking processing region. Accordingly, when a plurality of images including the input image are displayed, appropriate masking processing according to the display position of the input image is able to be performed.

The image processing device according to an aspect 5 of the disclosure may further include an image combining unit that generates a combined image by (1) combining a plurality of masking processed images generated by the masking processing unit, each of which is the masking processed image obtained by performing the masking processing for the masking processing region, or (2) combining at least one of the masking processed images generated by the masking processing unit and the incorporated image, in which the luminance data creation unit may create the luminance data on a basis of the combined image, in the aspect 4.

According to the aforementioned configuration, the image combining unit combines a plurality of images including an input image for which masking processing is performed earlier. The luminance data creation unit creates the luminance data on the basis of the combined image combined by the image combining unit. Accordingly, the luminance data creation unit is able to create the luminance data on the basis of the image that is appropriately subjected to the masking processing and is combined.

In the image processing device according to an aspect 6 of the disclosure, the region specification unit may generate an image in a rectangular shape, which includes the input image and the incorporated image, in accordance with relative display positions of the input image and the incorporated image, and specify the masking processing region in the image in the rectangular shape in accordance with the relative display positions, in the aspect 4.

According to the aforementioned configuration, the region specification unit specifies the masking processing region in the image in the rectangular shape, which includes the input image and the incorporated image, in accordance with the relative display positions of the input image and the incorporated image. The masking processing unit performs the masking processing for the specified masking processing region and creates the masking processed image. Accordingly, the luminance data creation unit is able to create the luminance data on the basis of the image appropriately subjected to the masking processing.

A display device according to an aspect 7 of the disclosure further includes a storage unit that stores an incorporated image serving as an image that has a shape corresponding to a shape of the display region or at least a part of the shape of the display region, in any of the aspects 1 to 6.

According to the aforementioned configuration, the display device is able to display the incorporated image separately from the input image or at the same time with the input image as needed.

A display device according to an aspect 8 of the disclosure includes: the image processing device according to any of the aspects 1 to 7; a display unit that displays the output image; and an illumination device constituted by light sources that illuminate the display unit with light.

According to the aforementioned configuration, the display unit displays the output image created by the image processing device. Moreover, the light sources illuminate the display unit with light on the basis of the luminance data created by the image processing device. Accordingly, the display device is able to display the image on the basis of the output image and the luminance data that are created by the image processing device. That is, the display device is able to display the image in which deterioration in image quality is suppressed.

In the display device according to an aspect 9 of the disclosure, the display unit includes a frame that has a rectangular shape and shields a region other than the display region in the nonrectangular shape, in the aspect 8.

According to the aforementioned configuration, the display region in the nonrectangular shape is formed by the frame, and the image is able to be displayed in the display region without deterioration in image quality.

In the display device according to an aspect 10 of the disclosure, the illumination device has the light sources disposed only in a region facing the display region, in the aspect 9.

According to the aforementioned configuration, the number of light sources is able to be reduced as compared to a case where light sources are disposed correspondingly to a whole of a display panel in a rectangular shape.

In the display device according to an aspect 11 of the disclosure, the illumination device includes an illumination device control circuit that controls lighting of the light sources, the light sources are disposed in a region facing a whole of the display unit, and the illumination device control circuit performs control so that only a light source disposed in a region corresponding to the display region is turned on, in the aspect 9.

According to the aforementioned configuration, since a general illumination device is able to be used in the display device, it is not necessary to manufacture an illumination device in which the number of light sources is reduced.

In the display device according to an aspect 12 of the disclosure, the light sources are disposed in a region facing a whole of the display unit, and wiring of a light source shielded by the frame is cut or no wiring is provided, in the aspect 9.

According to the aforementioned configuration, an effect similar to that of the aspect 11 is exerted.

An image processing method according to an aspect 13 of the disclosure is an image processing method of generating an output image displayed on a display device that controls lighting of a plurality of light sources corresponding to a display region in a nonrectangular shape, and the image processing method includes the steps of: using a region other than the display region in an input image, which is input from outside, as a masking processing region to perform masking processing for the masking processing region and generating a masking processed image; creating luminance data, which indicates luminance of the plurality of light sources when an output image corresponding to the input image is displayed, on a basis of the masking processed image; and creating the output image on a basis of the luminance data and the input image or the masking processed image.

According to the aforementioned configuration, an effect similar to that of the aspect 1 is exerted.

Each of the image processing devices according to the respective aspects of the disclosure may be implemented by a computer. In this case, a control program of the image processing device, which causes the computer to operate as each unit (software element) included in the image processing device to thereby achieve the image processing device by the computer, and a computer-readable recording medium that records the control program are also encompassed in the scope of the disclosure.

The disclosure is not limited to each of the embodiments described above and may be modified in various manners within the scope indicated in the claim, and an embodiment achieved by appropriately combining techniques disclosed in each of different embodiments is also encompassed in the technical scope of the disclosure. Further, by combining the technical means disclosed in each of the embodiments, a new technical feature may be formed.

### CROSS-REFERENCE OF RELATED APPLICATION

This application claims the benefit of priority to Japanese Priority Patent Application: 2017-233622 filed on Dec. 5, 2017, which is incorporated herein by reference in its entirety.

### REFERENCE SIGNS LIST

1, 1A, 1B, 1D, 1E, 1F, 1H display device
10, 10A, 10B, 10D, 10E, 10F, 10H image processing device
11 masking processing unit
12 luminance data creation unit
13 output image creation unit
14 down-conversion processing unit
15 region specification unit
16 format conversion unit
17 image combining unit
18 FRC processing unit
20, 20C, 20D, 20G display unit
21 liquid crystal panel (display panel)
22 frame
23, 231, 232, 233 light-emitting surface
30, 31, 32, 33 illumination device
302 light source
306 illumination device control circuit

1. An image processing device that generates an output image displayed on a display device that controls a plurality of light sources corresponding to a display region in a nonrectangular shape, the image processing device comprising:
a masking processing unit that uses a region other than the display region in an input image, which is input from outside, as a masking processing region to perform masking processing for the masking processing region and generates a masking processed image;
a luminance data creation unit that creates luminance data, which indicates luminance of the plurality of light sources when an output image corresponding to the input image is displayed, on a basis of the masking processed image; and
an output image creation unit that creates the output image on a basis of the luminance data and the input image or the masking processed image.

2. The image processing device according to claim 1, further comprising
a down-conversion processing unit that reduces a size of the input image, wherein
the masking processing unit performs the masking processing for the input image that is reduced by the down-conversion processing unit.

3. The image processing device according to claim 1, further comprising
a format conversion unit that converts a format of the input image, wherein
the output image creation unit creates the output image on a basis of the luminance data and the input image the format of which is converted by the format conversion unit.

4. The image processing device according to claim 1, further comprising a region specification unit that specifies, in accordance with (1) relative display positions of a plurality of input images, each of which is the input image input from outside, or (2) relative display positions of at least one of the input images and an incorporated image serving as an image that is prepared in advance and having a shape corresponding to at least a part of a shape of the display region, a region other than the display region in the input image as the masking processing region.

5. The image processing device according to claim 4, further comprising an image combining unit that generates a combined image by (1) combining a plurality of masking processed images generated by the masking processing unit, each of which is the masking processed image obtained by performing the masking processing for the masking processing region, or (2) combining at least one of the masking processed images generated by the masking processing unit and the incorporated image, wherein
the luminance data creation unit creates the luminance data on a basis of the combined image.

6. The image processing device according to claim 4, wherein
the region specification unit
generates an image in a rectangular shape, which includes the input image and the incorporated image, in accordance with relative display positions of the input image and the incorporated image, and
specifies the masking processing region in the image in the rectangular shape in accordance with the relative display positions.

7. The image processing device according to claim 1, further comprising a storage unit that stores an incorporated image serving as an image that has a shape corresponding to a shape of the display region or at least a part of the shape of the display region.

8. A display device comprising:
the image processing device according to claim 1;
a display unit that displays the output image; and
an illumination device constituted by a plurality of light sources that illuminate the display unit with light.

9. The display device according to claim 8, wherein the display unit includes a frame that has a rectangular shape and shields a region other than the display region in the nonrectangular shape.

10. The display device according to claim 9, wherein the illumination device includes the light sources only in a region facing the display region.

11. The display device according to claim 9, wherein
the illumination device includes an illumination device control circuit that controls lighting of the light sources,
the light sources are disposed in a region facing a whole of the display unit, and
the illumination device control circuit performs control so that only a light source disposed in a region corresponding to the display region is turned on.

12. The display device according to claim 9, wherein
the light sources are disposed in a region facing a whole of the display unit, and
wiring of a light source shielded by the frame is cut or no wiring is provided.

13. An image processing method of generating an output image displayed on a display device that controls a plurality of light sources corresponding to a display region in a nonrectangular shape, the image processing method comprising the steps of:
using a region other than the display region in an input image, which is input from outside, as a masking processing region to perform masking processing for the masking processing region and generating a masking processed image;
creating luminance data, which indicates luminance of the plurality of light sources when an output image corresponding to the input image is displayed, on a basis of the masking processed image; and
creating the output image on a basis of the luminance data and the input image or the masking processed image.

14. A non-transitory computer-readable recording medium that records a program causing a computer to function as an image processing device that generates an output image displayed on a display device that controls a plurality of light sources corresponding to a display region in a nonrectangular shape, and
causing the computer to function as
a masking processing unit that uses a region other than the display region in an input image, which is input from outside, as a masking processing region to perform masking processing for the masking processing region and generates a masking processed image,
a luminance data creation unit that creates luminance data, which indicates luminance of the plurality of light sources when an output image corresponding to the input image is displayed, on a basis of the masking processed image, and
an output image creation unit that creates the output image on a basis of the luminance data and the input image or the masking processed image.

15. (canceled)
